(19) United States
(12) Patent Application Publication
(10) Pub. No.: US 2023/0001663 A1
(43) Pub. Date: Jan. 5, 2023

(54) ROTARY TABLET PRESS WITH MULTIPLE ROW TURRET

(71) Applicant: INDUSTRIAL PHARMACEUTICAL RESOURCES, INC., Bartlett, IL (US)

(72) Inventors: Joseph I. Dougherty, JR., Glen Ellyn, IL (US); Mark Tate, Glen Ellyn, IL (US)

(21) Appl. No.: 17/841,833

(22) Filed: Jun. 16, 2022

Related U.S. Application Data
(60) Provisional application No. 63/217,827, filed on Jul. 2, 2021.

(51) Int. Cl. B30B 15/02; B30B 11/08; B30B 15/00

(52) U.S. Cl. CPC B30B 15/022; B30B 11/08; B30B 15/0023; B30B 15/026

(57) ABSTRACT

As described herein, a multiple row turret module is for use in a rotary tablet press comprising a pressure roll assembly and a turret drive assembly. The multiple row turret module includes a turret comprising a hub selectively engageable by the drive assembly for rotation about a vertical axis. The hub supports a die table and upper and lower guideways defining a plurality of stations. Each station comprises an upper punch opening in the upper guideway and an aligned die opening in the die table and a lower punch opening in the lower guideway. The stations are aligned in a plurality of concentric rows. A plurality of upper punches are provided, one in each of the upper punch openings. A plurality of lower punches are provided, one in each of the lower punch openings. An upper cam assembly is supported above the upper guideway for selectively reciprocating the plurality of concentric rows of upper punches toward and away from the die openings responsive to rotation of the turret. A lower cam assembly is supported below the lower guideway for selectively reciprocating the plurality of concentric rows of lower punches toward and away from the die openings responsive to rotation of the turret. The pressure roll assemblies selectively engage the upper and lower punches responsive to rotation of the turret to compress a granulation into a tablet at the stations.

### BACKGROUND OF THE INVENTION

### Field of the Invention

This invention relates to rotary tablet presses and, more particularly to multiple row turret and cam assemblies.

### Background of the Invention

Oral dosage medication is typically manufactured by directly compressing granulation on a rotary tablet press. Tooling is used on the tablet press to identify and produce specific products. The tooling consists of an upper punch, lower punch, and a die. To form a tablet, granulated powder material must be fed into a cavity formed by two punches and a die. The punches are pressed together with sufficient force to fuse the powder into a tablet.

In a conventional rotary tablet press, a turret is rotatable about a vertical axis and carries a plurality of dies. Each die has associated upper and lower punches driven by upper and lower cams to compress the granulation into a tablet. An upper punch, a lower punch and a die are together referred to as a station.

Such rotary tablet presses are provided by various manufacturers and described, for example, in U.S. Pat. Nos. 4,988,275 and 6,676,863 and EP1050399.

A typical rotary tablet press turret includes a plurality of stations aligned in a circle proximate an outer peripheral edge of the turret. The number of stations depends on various factors, including the size of the turret and the size of the dies and punches. While there is a desire to maximize output of tablets with the press, this is limited by the available space to accommodate each station. Limitations may also result when multi-tip punches are used.

The present invention is directed to improvements in design of a turret and cams.

### SUMMARY OF THE INVENTION

The present invention relates to a turret including multiple concentric rings of stations. As such, the number of tablets produced with a turret can increase by a factor corresponding to the number of rows of stations. In an exemplary embodiment there are two rows of stations which approximately doubles output. Additional rows could also be provided.

In accordance with one aspect of the invention, a multiple row turret module is provided for use in a rotary tablet press comprising a pressure roll assembly and a turret drive assembly. The multiple row turret module comprises a turret including a hub selectively engageable by the drive assembly for rotation about a vertical axis. The hub supports a die table and upper and lower guideways defining a plurality of stations. Each station comprises an upper punch opening in the upper guideway and an aligned die opening in the die table and a lower punch opening in the lower guideway. The stations are aligned in first and second concentric rows. A plurality of upper punches are provided, one in each of the upper punch openings. A plurality of lower punches are provided, one in each of the lower punch openings. An upper cam assembly is supported above the upper guideway for selectively reciprocating the first and second concentric rows of upper punches toward and away from the die openings responsive to rotation of the turret. A lower cam assembly is supported below the lower guideway for selectively reciprocating the first and second concentric rows of lower punches toward and away from the die openings responsive to rotation of the turret. The pressure roll assemblies selectively engage the upper and lower punches responsive to rotation of the turret to compress a granulation into a tablet at the stations.

It is a feature that the turret may be of one-piece construction or assembled from a plurality of components.

It is another feature that the die table has a plurality of through openings spaced about its periphery and further comprising a plurality of die, one for each through opening, and wherein each die comprises a plurality of the aligned die openings. Lock screws may be provided for removably mounting the die in the through openings.

It is a further feature that the upper cam assembly comprises an upper cam body supported above the hub and a plurality of upper cams mounted to the upper cam body. The upper cams are sized to reciprocate the first and second rows of upper punches. The lower cam assembly comprises a lower cam base supporting the hub for rotation relative thereto and a plurality of lower cams are mounted to the lower cam base. The lower cams are sized to reciprocate the first and second rows of lower punches.

It is still another feature that the turret module comprises an equal number of stations in each of the first and second concentric rows.

In accordance with another aspect of the invention, a multiple row turret module is provided for use in a rotary tablet press comprising a pressure roll assembly and a turret drive assembly. The multiple row turret module comprises a turret including a hub selectively engageable by the drive assembly for rotation about a vertical axis. The hub supports a die table and upper and lower guideways defining a plurality of stations. Each station comprises an upper punch opening in the upper guideway and an aligned die opening in the die table and a lower punch opening in the lower guideway. The stations are aligned in a plurality of concentric rows. A plurality of upper punches are provided, one in each of the upper punch openings. A plurality of lower punches are provided, one in each of the lower punch openings. An upper cam assembly is supported above the upper guideway for selectively reciprocating the plurality of concentric rows of upper punches toward and away from the die openings responsive to rotation of the turret. A lower cam assembly is supported below the lower guideway for selectively reciprocating the plurality of concentric rows of lower punches toward and away from the die openings responsive to rotation of the turret. The pressure roll assemblies selectively engage the upper and lower punches responsive to rotation of the turret to compress a granulation into a tablet at the stations.

Further features and advantages will be apparent from the specification and the drawings.

### BRIEF DESCRIPTION OF THE DRAWINGS

FIG. 1 is a perspective view of a rotary tablet press machine including a turret module in accordance with the invention;

FIG. 2 is a perspective view of an exemplary turret module in accordance with the invention comprising two rows of stations, with punches removed for clarity;

FIG. 3 is a sectional view of the turret module of FIG. 2;

FIG. 4 is a perspective view of the turret of the turret module of FIG. 2 with a die shown removed;

FIG. 5 is a side view of the turret module of FIG. 2 with punches added and an upper cam body removed;

FIG. 6 is an exploded view of the turret module of FIG. 5;

FIG. 7 is a top view of the turret module of FIG. 5;

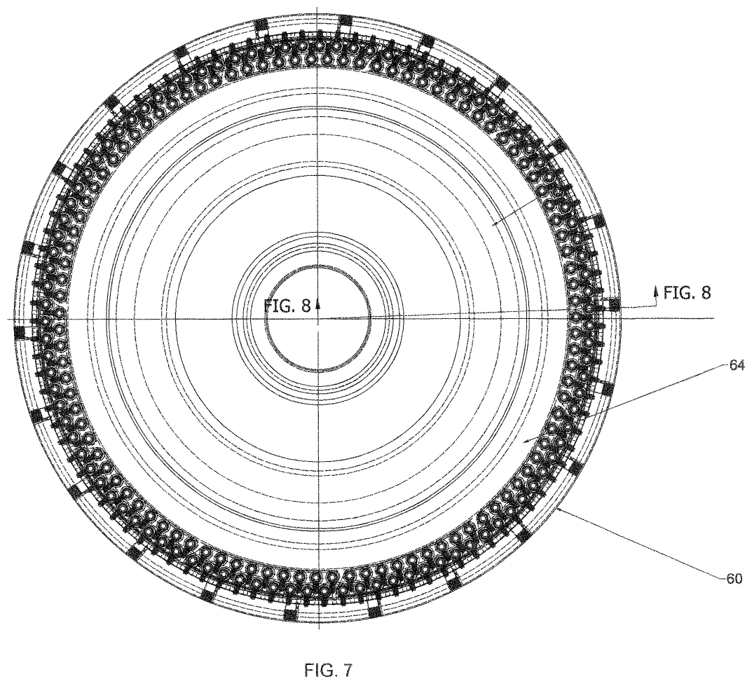

FIG. 8 is a sectional view taken along the line 8-8 of FIG. 7;

FIG. 9 is a perspective view of an alternative double row turret module in accordance with the invention; and

FIG. 10 is an exploded view of the turret of FIG. 9.

### DETAILED DESCRIPTION OF THE INVENTION

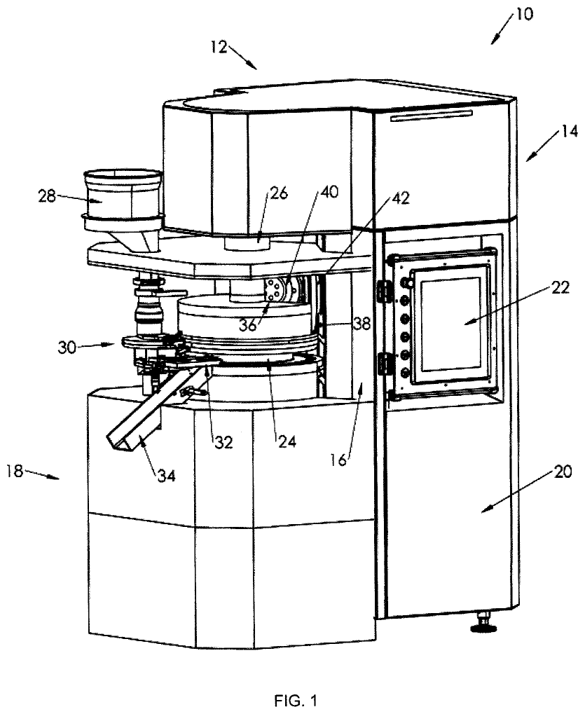

Referring initially to FIG. 1 a rotary tablet press machine 10 in accordance with the invention is illustrated. The rotary tablet press machine 10 comprises a press assembly 12 and a control cabinet 14. The press assembly 12 comprises a press frame 16 and a removeable module 18. The removable module 18 may be physically and electrically separated from the press frame 16 for maintenance and changing turret configuration. The configuration of the rotary tablet press machine 10 incorporates general features described in application Ser. No. 17/326,653, owned by the Applicant herein, the specification is which is hereby incorporated by reference herein.

The control cabinet 14 comprises a housing 20 which supports the press assembly 12. The particular configuration of the housing 20 is illustrated by way of example only. The control cabinet 14 includes space for control components (not shown) and an operator interface 22, which do not themselves form part of the invention. Provision is also made for providing necessary electrical connections between control devices in the control cabinet 14 and the press assembly 12.

A turret module 24 in accordance with the invention is suitably mounted in the removable module 18 and is driven by a drive assembly 26 of the press assembly 12 for driving the turret module 24 from above. A powder supply system 28 in the removable module 18 provides granulated powder to a feeder 30. The feeder 30 fills each die with granulated powder as the station passes the feeder 30, as is well known. A tablet take-off 32 guides the formed tablet as it is ejected into a discharge chute 34.

The press frame 12 includes two motorized pressure roller assemblies 36 and 38. The first roller assembly 36 has an upper roller 40 and a lower roller (not shown). The second roller assembly 38 has an upper roller 42 and a lower roller (not shown). The upper rollers 40 and 42 and the associated lower rollers are in a plane perpendicular to one another. Although not shown, the roller assemblies 36 and 38 are supported on linear guides moveable on the rails by respective drives.

The general structure of the rotary tablet press 10 is by way of example only. The invention described herein is particularly directed to the turret module 24 and, particularly, to a turret module including multiple concentric rings of stations to maximize output production.

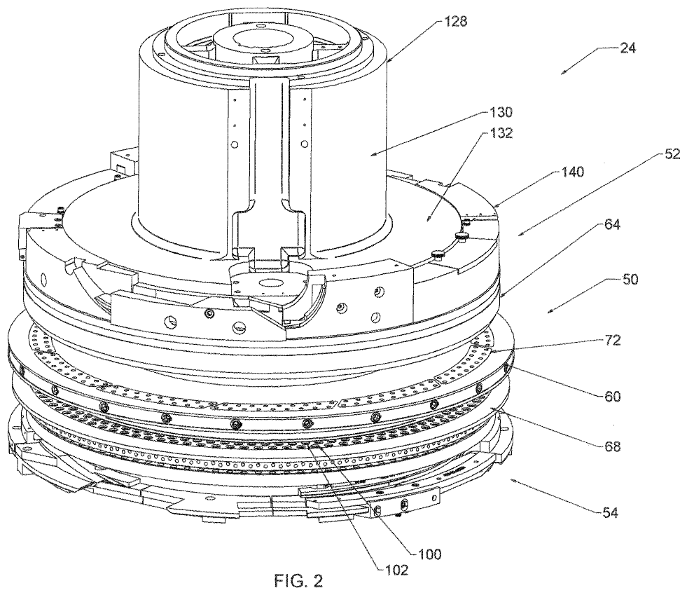

Referring to FIG. 2, the turret module 24 is illustrated in greater detail. The turret module 24 comprises, in pertinent part, a rotating turret 50, an upper cam assembly 52 and a lower cam assembly 54.

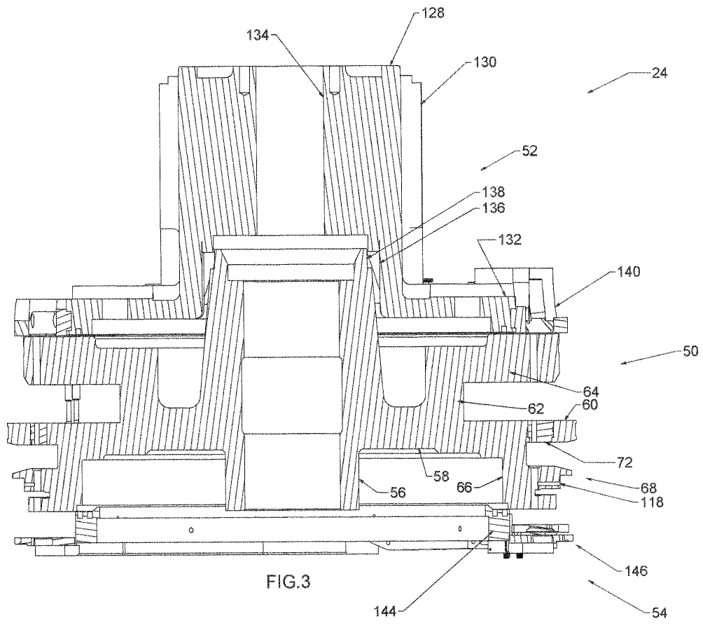

Referring to FIG. 3, the turret 50 is of one-piece construction and comprises a central, generally cylindrical hub 56. An annular ring 58 extends outwardly from the hub 56. An outer peripheral portion of the ring 58 defines a die table 60. A short cylindrical wall 62 extends upwardly from the ring 58 and is then turned outwardly to define an annular upper guideway 64. A short cylindrical wall 66 extends downwardly from the ring 58 and is then turned outwardly to define an annular lower guideway 68.

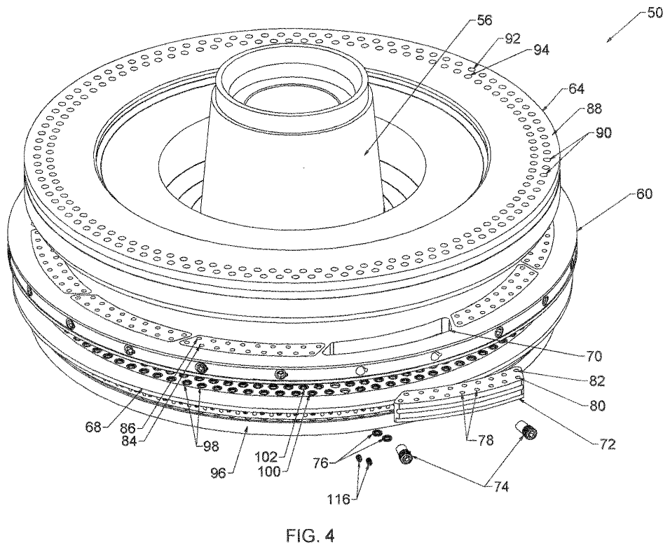

Referring also to FIG. 4, the die table 60 comprises a plurality of arcuate through openings 70. In the illustrated embodiment there are eleven arcuate through openings 70. The openings 70 are equally angularly spaced about the die table 60. Each opening 70 receives a die 72. In the illustrated embodiment there are eleven die 72. Each die 72 is secured in its associated through opening 70 using lock screws 74 and seals 76.

Each die 72 includes a plurality of die openings 78 arranged in an outer or first arcuate row 80 and an inner or second arcuate row 82. Each row 80 and 82 has nine openings 78. As a result, each die 72 has eighteen die openings 78. Thus, the die table 60 has one hundred and ninety-eight die openings 78 as there are eleven die 72. Relative to the die table 60, the arcuate rows 80 and 82 are aligned so that the die openings 78 are in first and second concentric rows 84 and 86.

The upper guideway 64 comprises an annular body 88 having a plurality of upper punch openings 90. The upper punch openings 90 are aligned in an outer row 92 and a concentric inner row 94. The number and alignment of the upper punch openings 90 in the rows 92 and 94 corresponds to that of the die openings 78 in the die table outer row 84 and inner row 86, respectively.

Similarly, the lower guideway 68 comprises an annular body 96 having a plurality of lower punch openings 98. The lower punch openings 90 are aligned in an outer row 100 and a concentric inner row 102, see also FIG. 2. The number and alignment of the lower punch openings 98 in the rows 100 and 102 corresponds to that of the die openings 78 in the die table outer row 84 and inner row 86, respectively.

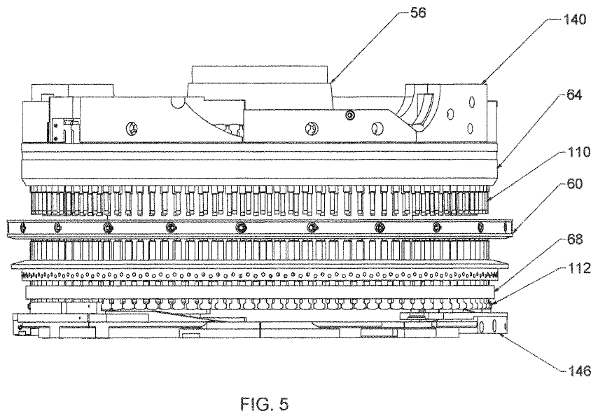

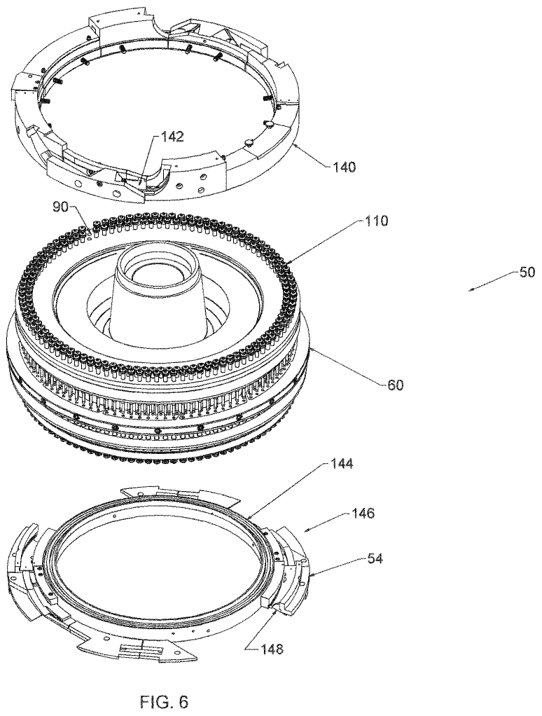

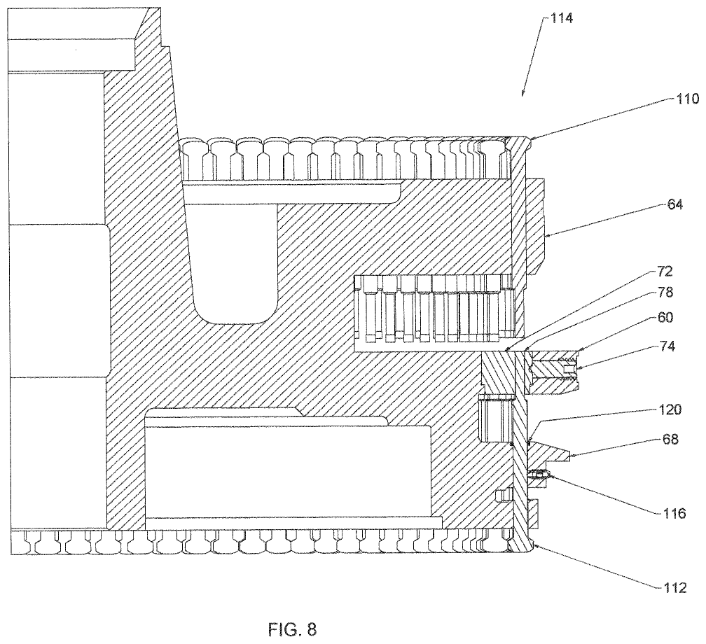

As shown generally in FIGS. 5 and 6, each upper punch opening 90 receives an upper punch 110. Each lower punch opening 98 receives a lower punch 112. As noted previously, each aligned upper punch 110 and upper punch opening 90, and corresponding lower punch 112 and lower punch opening 98, and die opening 78 (which is typically referred to as a die) are together referred to as a station 114, see FIG. 8. Thus, in the illustrated embodiment, there are one hundred and ninety-eight stations 114. The lower punches 112 are secured in the lower punch openings 98 using punch holding plugs 116 threaded into radially extending openings 118, see FIG. 3, in the lower guideway 68. A lower punch seal 120 seals each lower punch 112 in the lower guideway 68.

Referring to FIG. 3, the upper cam assembly 52 includes an upper cam body 128 including a cylindrical neck 130 connected to an annular shoulder 132. The neck 130 has a cylindrical bore 134 and a lower counterbore 136. The lower counterbore 136 receives an upper end 138 of the turret hub 56. The turret 50 is rotatable relative to the upper cam body 128. A double row upper cam track 140 is secured about the periphery of the shoulder 132. The upper cam track 140 is configured according to the machine parameters of the tablet press 10, as will be apparent, but includes a track 142 to accommodate the two rows of upper punches 110, see FIG. 6.

The lower cam assembly 54 includes a cylindrical wall 144 which supports the turret short cylindrical wall 66 for rotation relative thereto. A double row lower cam track 146 is secured about the periphery of the cylindrical wall 144. The lower cam track 146 is configured according to the machine parameters of the tablet press 10, as will be apparent, but includes a track 148 to accommodate the two rows of lower punches 112.

The upper cam assembly 52 and the lower cam assembly 54 are fixedly mounted relative to the tablet press 10. The turret 50 is operatively driven by the drive assembly 26 via a coupler (not shown) which extends downward through the upper cam body bore 134 and connects to the hub 56 to rotate the turret 50.

The upper punches 110 are operated by the upper cam track 140 in a conventional manner as by reciprocating the upper punches 110 down and up, toward and away from the die openings 78, responsive to rotation of the turret 50. The lower punches 112 are also operated by the lower cam track 146 in a conventional manner by reciprocating the lower punches 112 up and down, toward and away from the die openings 78, responsive to rotation of the turret 50.

Particularly, as is conventional, during much of the rotation of the turret 50, the lower cam track 146 generally supports the lower punches 112 so that the lower punch 112 fills the die opening 78, as shown in FIG. 8. The lower cam track includes a fill cam (not shown) which lowers the lower punches 112 to allow the die opening to be filled with the granulated powder from the feeder 30, see also FIG. 1. During much of the rotation of the turret 50, the upper cam track 140 generally supports the upper punches 110 spaced above the die openings 78 as also shown in FIG. 8. At a rotational position subsequent to the fill cam, discussed above, the upper cam track 144 includes an upper lowering cam (not shown) that lowers the upper punches 110 so that they enter the die openings 78, which are filled with powder. Immediately thereafter, the compression roller assemblies 36 and 38 compress the upper punches 110 and the lower punches 112 to form the tablet. The upper cam track 144 then uses an upper lifting cam (not shown) to raise the upper punches 110. The lower cam track 146 includes an ejection cam (not shown) which raises the lower punches 112 to eject the formed tablet into the tablet take-off 32.

This general operation discussed above is conventional, and the exact configuration will depend, in part, on the tablet being manufactured. The invention herein is particularly directed to having multiple rows of stations to significantly increase output production with a given turret module.

In the illustrated embodiment, the turret module 24 comprises two rows of stations. As will be apparent, the turret module could include additional rows, such as three or four, depending on tablet size and shape as well as available size of the turret 50. The number of stations can differ. In the illustrated embodiment, the first and second rows have an identical number of stations. As is apparent, the rows could have different numbers of stations. Particularly, depending on size constraints, the inner row may have fewer stations than the outer row.

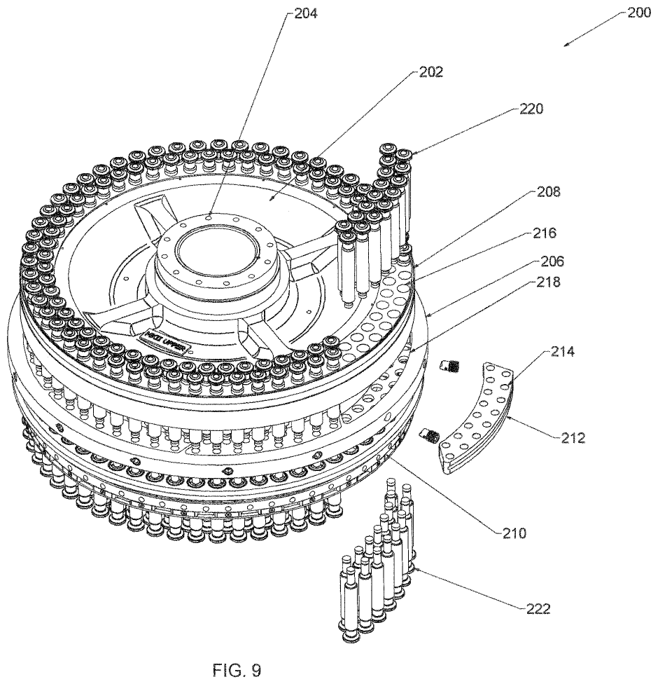

FIG. 9 illustrates a multiple row turret module 200 in accordance with another embodiment of the invention. In this embodiment there are one hundred and eighteen stations, also arranged in two concentric rows. This turret module 200 is also usable in the tablet press 10 of FIG. 1.

The multiple row turret module 200 comprises a turret 202 comprising a hub 204 selectively engageable by the drive assembly 26 for rotation about a vertical axis. The hub 204 supports a die table 206 and upper and lower guideways 208 and 210, respectively, defining a plurality of stations. The die table 206 supports seven removable die 212 each having sixteen die openings 214 arranged in first and second rows, as with the turret 50. Each station comprises an upper punch opening 216 in the upper guideway 208 and an aligned die opening 214 in the die table 206 and a lower punch opening 218 in the lower guideway 210. The stations are aligned in first and second concentric rows. A plurality of upper punches 220 are provided, one in each of the upper punch openings 216. A plurality of lower punches 222 are provided, one in each of the lower punch openings 218.

Although not shown, an upper cam assembly is supported above the upper guideway 208 for selectively reciprocating the first and second concentric rows of upper punches 220 toward and away from the die openings 214 responsive to rotation of the turret 200. A lower cam assembly (not shown) is supported below the lower guideway 210 for selectively reciprocating the first and second concentric rows of lower punches 222 toward and away from the die openings 214 responsive to rotation of the turret 200. The pressure roll assemblies selectively engage the upper and lower punches responsive to rotation of the turret to compress a granulation into a tablet at the stations.

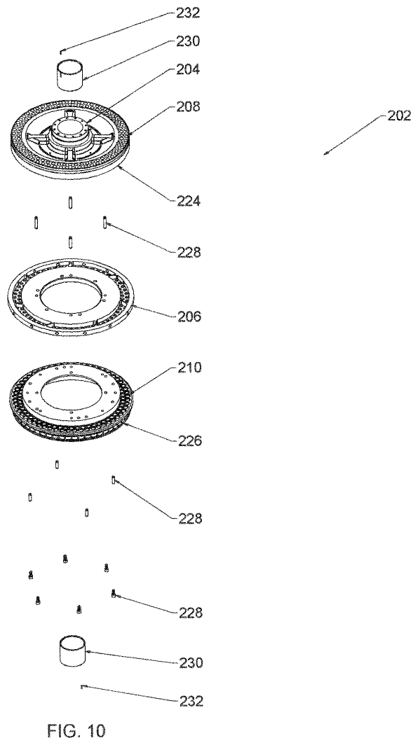

In this embodiment, the turret 202 is formed of several components fastened together. FIG. 10 shows an exploded view of the turret. 202. The turret 202 comprises an upper turret 224 including the hub 208 and the upper guideway 208. A lower turret 226 comprising the lower guideway 210. The upper turret 224, the die table 206 and the lower turret 226 are secured together using a plurality of fasteners 228. The turret also comprises a pair of bush on columns 230 secured using fasteners 232.

It will be appreciated by those skilled in the art that there are many possible modifications to be made to the specific forms of the features and components of the disclosed embodiments while keeping within the spirit of the concepts disclosed herein. Although a few embodiments have been described in detail above, other modifications are possible.

The foregoing disclosure of specific embodiments is intended to be illustrative of the broad concepts comprehended by the invention.

1. A multiple row turret module for use in a rotary tablet press comprising a pressure roll assembly and a turret drive assembly, the multiple row turret module comprising:
a turret comprising a hub selectively engageable by the drive assembly for rotation about a vertical axis, the hub supporting a die table and upper and lower guideways defining a plurality of stations, each station comprising an upper punch opening in the upper guideway and an aligned die opening in the die table and a lower punch opening in the lower guideway, the stations being aligned in first and second concentric rows;
a plurality of upper punches, one in each of the upper punch openings;
a plurality of lower punches, one in each of the lower punch openings;
an upper cam assembly supported above the upper guideway for selectively reciprocating the first and second concentric rows of upper punches toward and away from the die openings responsive to rotation of the turret; and
a lower cam assembly supported below the lower guideway for selectively reciprocating the first and second concentric rows of lower punches toward and away from the die openings responsive to rotation of the turret;
wherein the pressure roll assemblies selectively engage the upper and lower punches responsive to rotation of the turret to compress a granulation into a tablet at the stations.

2. The multiple row turret module of claim 1 wherein the turret is of one-piece construction.

3. The multiple row turret module of claim 1 wherein the die table has a plurality of through openings spaced about its periphery and further comprising a plurality of die, one for each through opening, and wherein each die comprises a plurality of the aligned die openings.

4. The multiple row turret module of claim 3 further comprising lock screws removably mounting the die in the through openings.

5. The multiple row turret module of claim 1 wherein the upper cam assembly comprises an upper cam body supported above the hub and a plurality of upper cams mounted to the upper cam body.

6. The multiple row turret module of claim 5 wherein the upper cams are sized to reciprocate the first and second rows of upper punches.

7. The multiple row turret module of claim 1 wherein the lower cam assembly comprises a lower cam base supporting the hub for rotation relative thereto and a plurality of lower cams are mounted to the lower cam base.

8. The multiple row turret module of claim 7 wherein the lower cams are sized to reciprocate the first and second rows of lower punches.

9. The multiple row turret module of claim 1 wherein the turret module comprises an equal number of stations in each of the first and second concentric rows.

10. The multiple row turret module of claim 1 wherein the turret comprises an upper turret including the hub and the upper guideway and a lower turret comprising the lower guideway and wherein the upper turret, the die table and the lower turret are secured together using a plurality of fasteners.

11. A multiple row turret module for use in a rotary tablet press comprising a pressure roll assembly and a turret drive assembly, the multiple row turret module comprising:
a turret comprising a hub selectively engageable by the drive assembly for rotation about a vertical axis, the hub supporting a die table and upper and lower guideways defining a plurality of stations, each station comprising an upper punch opening in the upper guideway and an aligned die opening in the die table and a lower punch opening in the lower guideway, the stations being aligned in a plurality of concentric rows of stations;
a plurality of upper punches, one in each of the upper punch openings;
a plurality of lower punches, one in each of the lower punch openings;
an upper cam assembly supported above the upper guideway for selectively reciprocating the plurality of concentric rows of upper punches toward and away from the die openings responsive to rotation of the turret; and
a lower cam assembly supported below the lower guideway for selectively reciprocating the plurality of concentric rows of lower punches toward and away from the die openings responsive to rotation of the turret;
wherein the pressure roll assemblies selectively engage the upper and lower punches responsive to rotation of the turret to compress a granulation into a tablet at the stations.

12. The multiple row turret module of claim 11 wherein the turret is of one-piece construction.

13. The multiple row turret module of claim 11 wherein the die table has a plurality of through openings spaced about its periphery and further comprising a plurality of die, one for each through opening, and wherein each die comprises a plurality of the aligned die openings.

14. The multiple row turret module of claim 13 further comprising lock screws removably mounting the die in the through openings.

15. The multiple row turret module of claim 11 wherein the upper cam assembly comprises an upper cam body supported above the hub and a plurality of upper cams mounted to the upper cam body.

16. The multiple row turret module of claim 15 wherein the upper cams are sized to reciprocate the plurality of rows of upper punches.

17. The multiple row turret module of claim 11 wherein the lower cam assembly comprises a lower cam base supporting the hub for rotation relative thereto and a plurality of lower cams are mounted to the lower cam base.

18. The multiple row turret module of claim 17 wherein the lower cams are sized to reciprocate the plurality of rows of lower punches.

19. The multiple row turret module of claim 11 wherein the turret module comprises an equal number of stations in each of the plurality of concentric rows.

20. The multiple row turret module of claim 11 wherein the plurality of concentric rows comprises first and second concentric rows of stations.

21. The multiple row turret module of claim 11 wherein the turret comprises an upper turret including the hub and the upper guideway and a lower turret comprising the lower guideway and wherein the upper turret, the die table and the lower turret are secured together using a plurality of fasteners.
